(19) United States
(12) Patent Application Publication
(10) Pub. No.: US 2019/0138241 A1
(43) Pub. Date: May 9, 2019

(54) METHOD AND SYSTEM FOR STORING IMAGES

(71) Applicant: SZ DJI TECHNOLOGY CO., LTD., Shenzhen (CN)

(72) Inventors: Wei TUO, Shenzhen (CN); Qiang ZHANG, Shenzhen (CN); Zhiwei LIU, Shenzhen (CN); Ke WANG, Shenzhen (CN)

(21) Appl. No.: 16/242,169

(22) Filed: Jan. 8, 2019

Related U.S. Application Data
(63) Continuation of application No. PCT/CN2016/089313, filed on Jul. 8, 2016.

(51) Int. Cl. G06F 3/06; G06F 13/42; B64C 39/02; G06F 15/78

(52) U.S. Cl. CPC G06F 3/0655; G06F 3/0679; G06F 3/0604; B64C 2201/127; B64C 39/024; G06F 15/7807; G06F 2213/0026; G06F 13/4221

(57) ABSTRACT

Systems, methods, and/or devices are used for storing images. An electronic device includes an image sensor, a solid-state drive (SSD) that includes a Peripheral Component Interconnect Express (PCIe) compatible electrical interface, and a field-programmable gate array (FPGA) coupled to the image sensor and the SSD. The FPGA implements a PCIe intellectual property (IP) core. The FPGA is configured to: receive raw image data from the image sensor; process the raw image data to obtain processed image data; and transfer the processed image data to the SSD through the PCIe compatible electrical interface of the SSD, wherein the transfer through the PCIe compatible electrical interface is driven by the PCIe IP core of the FPGA.

### CROSS-REFERENCE TO RELATED APPLICATION

This application is a continuation of International Application No. PCT/CN2016/089313, filed on Jul. 8, 2016, the entire content of which is incorporated herein by reference.

### TECHNICAL FIELD

The disclosed embodiments relate generally to systems and methods for storing image data, and more particularly, but not exclusively, to using a Field Programmable Gate Array (FPGA) to drive a solid state drive (SSD) with a Peripheral Component Interconnect Express (PCIe) interface to store images.

### BACKGROUND

As SSD technology advances, SSD controllers are capable of providing increasing number of lanes for data transfer and higher rates of data transfer. The SATA interface standard is increasingly a bottleneck on data transfer rates due to encoding overhead and bandwidth limitations. PCIe is an alternative interface standard that offers various advantages over SATA, such as higher available bandwidth and a smaller physical footprint.

### SUMMARY

There is a need for systems and methods for image storage using a PCIe intellectual property (IP) core implemented in a field programmable gate array (FPGA) to drive communications with an SSD. Such systems and methods optionally complement or replace conventional methods for storing images. In comparison with alternative serial computer expansion bus standards, PCIe-compatible devices feature a smaller physical footprint, which is desirable for minimizing device size and weight. Minimizing size and weight is particularly important when image storage occurs in a movable object capable of flight, such as an unmanned aerial vehicle (UAV), to reduce power consumption and extend battery life. Implementing PCIe in an FPGA allows images to be processed at a high rate of throughput. In this way, high resolution images are stored by a system that has a small size and weight.

In accordance with some embodiments, a system for storing images comprises an image sensor; a solid-state drive (SSD) that includes a Peripheral Component Interconnect Express (PCIe) compatible electrical interface; and a field-programmable gate array (FPGA) coupled to the image sensor and the SSD. The FPGA implements a PCIe intellectual property (IP) core. The FPGA is configured to: receive raw image data from the image sensor; process the raw image data to obtain processed image data; and transfer the processed image data to the SSD through the PCIe compatible electrical interface of the SSD. The transfer through the PCIe compatible electrical interface is driven by the PCIe IP core of the FPGA.

In accordance with some embodiments, a method for storing images comprises, at an electronic device that includes an image sensor, a solid-state drive (SSD) that includes a Peripheral Component Interconnect Express (PCIe) compatible electrical interface, and a field-programmable gate array (FPGA) coupled to the image sensor and the SSD, wherein the FPGA implements a PCIe intellectual property (IP) core: receiving raw image data from the image sensor; processing the raw image data to obtain processed image data; and transferring the processed image data to the SSD through the PCIe compatible electrical interface of the SSD. The transfer through the PCIe compatible electrical interface is driven by the PCIe IP core of the FPGA.

In accordance with some embodiments, an unmanned aerial vehicle (UAV) comprises a movement mechanism; an image sensor; a solid-state drive (SSD) that includes a Peripheral Component Interconnect Express (PCIe) compatible electrical interface; and one or more processors. The movement mechanism carries the image sensor, the SSD, and the one or more processors during movement. The one or more processors includes a controller coupled to the movement mechanism and controls the movement mechanism. The one or more processors includes a field-programmable gate array (FPGA) that is coupled to the image sensor and the SSD. The FPGA implements a PCIe intellectual property (IP) core. The FPGA is configured to: receive raw image data from the image sensor; process the raw image data to obtain processed image data; and transfer the processed image data to the SSD through the PCIe compatible electrical interface of the SSD. The transfer through the PCIe compatible electrical interface is driven by the PCIe IP core of the FPGA.

### BRIEF DESCRIPTION OF THE DRAWINGS

FIG. 1 illustrates an image storage system, in accordance with some embodiments.

FIGS. 2A-2B illustrate FPGAs with hard implementations of PCIe IP cores, in accordance with some embodiments.

FIGS. 2C-2D illustrate FPGAs with soft implementations of PCIe IP cores, in accordance with some embodiments.

FIG. 3 illustrates a movable object environment (e.g., a UVA environment), in accordance with some embodiments.

FIG. 4 illustrates a movable object (e.g., a UVA), in accordance with some embodiments.

FIGS. 5A-5B are a flow diagram illustrating a method for storing images, in accordance with some embodiments.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Techniques for storing images (e.g., still images and/or video) using a PCIe IP core implemented on an FPGA are described herein. In some embodiments, the images are captured using a camera, such as a standalone camera or a camera that is a component of a mobile device (e.g., a handheld mobile device). In some embodiments, the images are captured using a camera that is a payload of a UAV or other remote controlled and/or autonomous vehicle. Storing data using an FPGA with a PCIe IP core allows high resolution image data, such as HD, 4K (e.g., 4Kp60), or higher resolution video, to be stored by a device that is small and lightweight. In some embodiments, the system and method for storing image data may also be used for storing other types of data where large data storage throughput is required, e.g., in commercial or scientific research settings, where large arrays of sensors (e.g., photo sensors, vibration sensors, etc.) capture raw sensor data needed for subsequent processing with a fast rate.

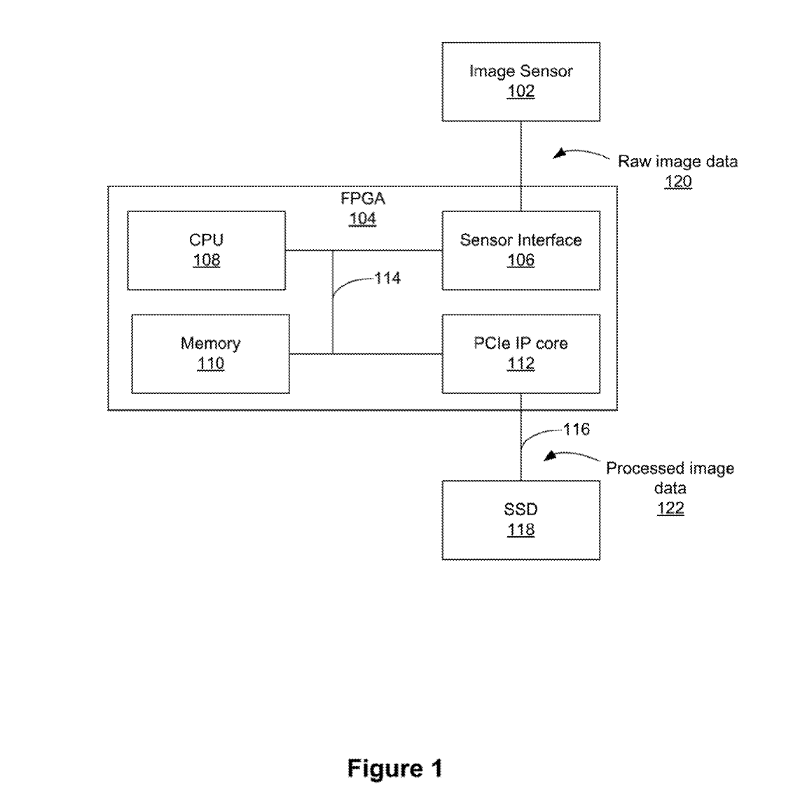

FIG. 1 illustrates an image storage system 100, in accordance with some embodiments. The image storage system 100 includes an image sensor 102, a FPGA 104, and an SSD 118.

The image sensor 102 is, e.g., a sensor that detects light, such as visible light, infrared light, and/or ultraviolet light. In some embodiments, the image sensor 102 includes, e.g., semiconductor charge-coupled devices (CCD), active pixel sensors using complementary metal-oxide-semiconductor (CMOS) and/or N-type metal-oxide-semiconductors (NMOS, Live MOS). In some embodiments, the image sensor 102 includes one or more arrays of photo sensors. In some embodiments, the image sensor 102 includes a digital camera.

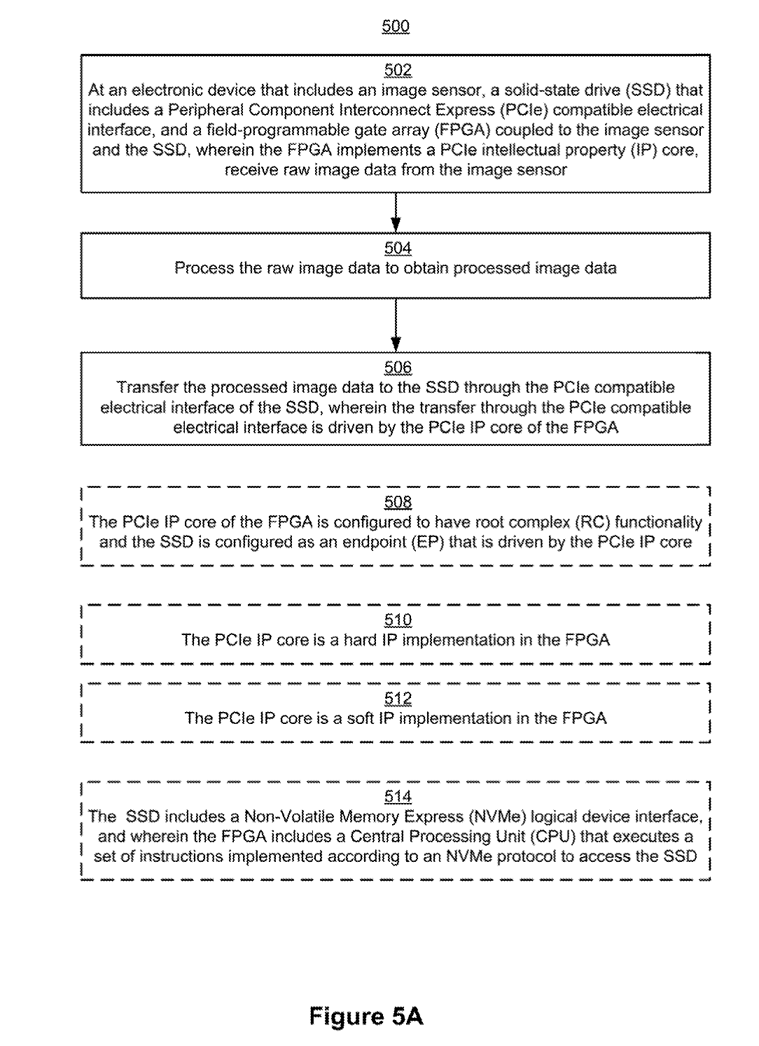

In some embodiments, the system 100 includes one or more optical devices that affect the focus of light that arrives at the image sensor 102. An optical device is, e.g., a lens or a device including multiple lenses (e.g., a compound lens). A lens is, e.g., a material having curved surfaces that give rise to lens properties, such as causing light rays to converge (e.g., at a focal length) and/or diverge. In some embodiments, one or more optical devices are moved relative to the image sensor 102 by one or more image device actuators, such as a hydraulic, pneumatic, electric, thermal, magnetic, and/or mechanical motor. For example, an optical device is moved by an image device actuator in response to control instructions received from, e.g., the FPGA 104 and/or processor(s) 402 (FIG. 4).

The FPGA 104 includes a PCIe IP Core 112. In some embodiments, the FPGA 104 includes a sensor interface 106, a central processing unit (CPU) 108, memory 110, and/or one or more communication buses 114 for interconnecting these components. The FPGA 104 receives raw image data 120 captured by the image sensor 102 via the sensor interface 106 and processes the raw image data to obtain processed (e.g., compressed) image data 122. In some embodiments, the compression performed on the raw image data 120 is lossless and/or near lossless compression. For example, high efficiency video coding (HEVC/H.265) compression is applied to the raw image data 120 to obtain the processed image data 122.

In some embodiments, the CPU 108 executes one or more instructions (e.g., instructions stored in the memory 110). For example, a Non-Volatile Memory Express (NVMe) protocol is implemented in software that is executed by the CPU 108 of the FPGA 104. The NVMe is a logical device interface specification for accessing the SSD 118, which is communicatively coupled to the FPGA 104 via a PCIe compatible electrical interface 116 (e.g., a PCIe bus). In some embodiments, the CPU 108 executes instructions associated with one or more module drivers.

The memory 110 is, e.g., double data rate (DDR) synchronous dynamic random-access memory (SDRAM). In some embodiments, the memory 110 is used to buffer image data received via the sensor interface 106 from the image sensor 102 until space is available in the SSD 118 to receive the image data. In some embodiments, e.g., if the size of memory 110 is insufficient to hold the raw image data, a swap space on SSD 118 is used for temporary storage of the raw image data 120 (e.g., until processing resources are available to perform compression on the raw image data 120).

The PCIe IP core 112 drives the transfer of the processed image data 122 through the PCIe compatible electrical interface 116 to the SSD 118. The PCIe IP core 112 communicates with the SSD 118 via the PCIe compatible electrical interface 116. In some embodiments, the PCIe compatible electrical interface 116 includes a SERDES-based interface for serializing and/or reserializing data for transfer via the interface 116.

In some embodiments, the PCIe IP core 112 is configured as a root complex (RC) and the SSD 118 is configured as an endpoint that is driven by the PCIe IP core 112, as opposed to being configure as an endpoint in parallel with the SSD (e.g., both of which are driven by a separate processor or computing device).

The PCIe version of PCIe IP core 112 is, e.g., PCIe 1.0, PCIe 2.0 or PCIe 3.0. The PCIe IP core 112 is configured to transfer data via, e.g., 1, 2, 4, 8, or 16 channels.

In comparison with alternative interface protocols (e.g., SATA 3.0), various implementations of a PCIe interface to an SSD have higher available bandwidth. For example, PCIe 3.0 uses a 128b/130b encoding scheme has reduced bandwidth loss due to bandwidth overhead in comparison with the 8/10-bit encoding of SATA. PCIe 3.0 is capable of providing higher bandwidth per channel in comparison with SATA 3.0 and PCIe is available with multiple channels per device (e.g., 1, 2, 4, 8, or 16 channels per device) whereas SATA has a single channel per device.

In some embodiments, the communication bus 114 uses an Advanced eXtensible Interface (AXI) bus architecture. In some embodiments, the AXI bus architecture includes at least two AXI bus interfaces used for, e.g., data transfer between the PCIe IP core 112 and at least one other component of the FPGA 104. For example, the AXI bus interfaces include an AXI lite bus interface (e.g., used for access requests for small amounts of data, such as requests to configure registers of the PCIe IP core 112) and/or an AXI full bus interface (e.g., used to access large amounts of data, such as data read from the address space of the memory 110). In some embodiments, the AXI lite bus interface is used by the CPU 108 for accessing an IP address register (e.g., of the PCIe IP core 112). In some embodiments, the AXI full bus interface is used for transfer of the image data (e.g., the raw image data).

The SSD 118 is a solid state storage device that stores data persistently. For example, the SSD 118 is non-volatile memory such as NAND-based flash memory. The SSD 118 stores processed image data transferred from the FPGA 104 via the PCIe compatible electrical interface 116. In some embodiments, the SSD 118 includes M.2 form factor card connectors that interface with PCIe physical cards. In comparison with alternative form factors, such as mSATA, M.2 connectors are available with smaller form factors and lower weights. M.2 reductions in component size and weight are particularly beneficial for UAVs, which can deliver increased power and range as a result of the reductions.

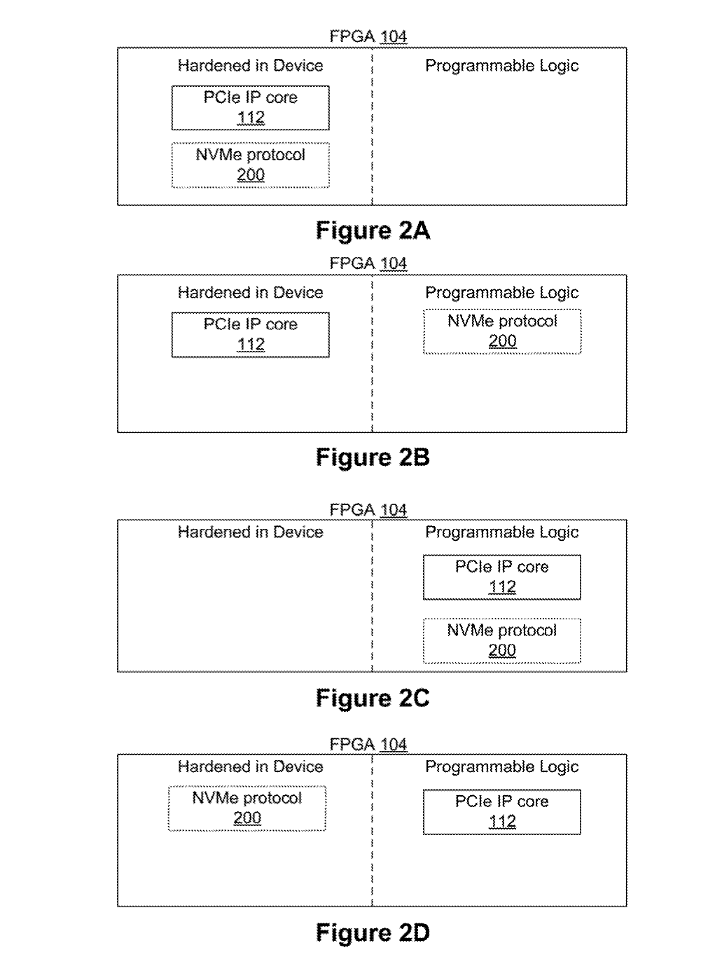

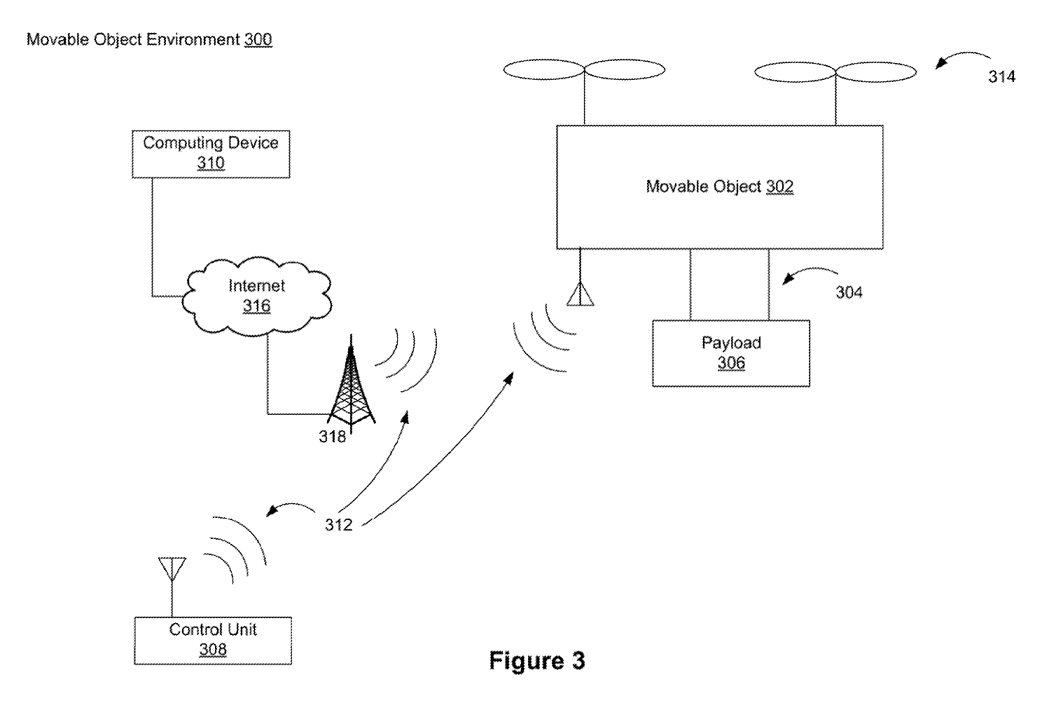

FIGS. 2A-2B illustrate various implementations of the PCIe IP core 112 in the FPGA 104, in accordance with some embodiments. The FPGA 104 in FIGS. 2A and 2B is shown including a “Hardened in Device” portion and a “Programmable Logic” portion. Logic that is hardened in the device (also referred to herein as a “hard implementation” and, in the case of the PCIe IP core 112, a “hard IP implementation”) is implemented within the fixed silicon design of the FPGA fabric. For example, a hard implementation involves fixed-function gate-level implementation of logic. A hard implementation is typically optimized for a particular FPGA and optionally, one or more of its proposed functions, and offers higher performance than a soft implementation. A soft implementation (also referred to as a “soft IP implementation,” e.g., in the case of the PCIe IP core 112) is implemented programmable logic, e.g., using hardware description language. Typically, a soft IP implementation allows a PCIe IP core 112 to be implemented across multiple FPGA products. One of the benefits of a soft implementation is that the programmed logic can be adapted to specific purposes and usage environment of the FPGA.

In FIGS. 2A and 2B, the PCIe IP core 112 is shown located in a portion of the FPGA 104 labeled “Hardened in Device,” indicating that the PCIe IP core 112 is a hard IP implementation in the FPGA 104. Implementing the PCIe IP core 112 as a hard IP implementation frees programmable logic in FPGA 104 (that might otherwise be used for PCIe IP core implementation) to be used for alternative functions.

As shown in FIG. 2A, in some embodiments, an NVMe protocol 200 for an NVMe logical device interface (e.g., the NVMe local device interface used by the SSD) is hardened in the FPGA 104.

As shown in FIG. 2B, in some embodiments, the NVMe protocol 200 for the NVMe local device interface is implemented by a set of software instructions (e.g., as a soft implementation), and the FPGA 104 includes a CPU that executes the set of software instructions implemented according to the NVMe protocol 200 to access the SSD.

In FIGS. 2C and 2D, the PCIe IP core 112 is shown located in a portion of the FPGA 104 labeled “Programmable Logic,” indicating that the PCIe IP core 112 is a soft IP implementation in the FPGA 104. Typically, a soft IP implementation of the PCIe IP core allows the core to be implemented across multiple FPGA products.

As shown in FIG. 2C, in some embodiments, the NVMe protocol 200 for the NVMe local device interface is implemented by a set of software instructions (e.g., as a soft implementation), and the FPGA 104 includes a CPU that executes the set of software instructions implemented according to the NVMe protocol 200 to access the SSD.

As shown in FIG. 2D, in some embodiments, the NVMe protocol 200 for an NVMe logical device interface (e.g., the NVMe local device interface used by the SSD) is hardened in the FPGA 104.

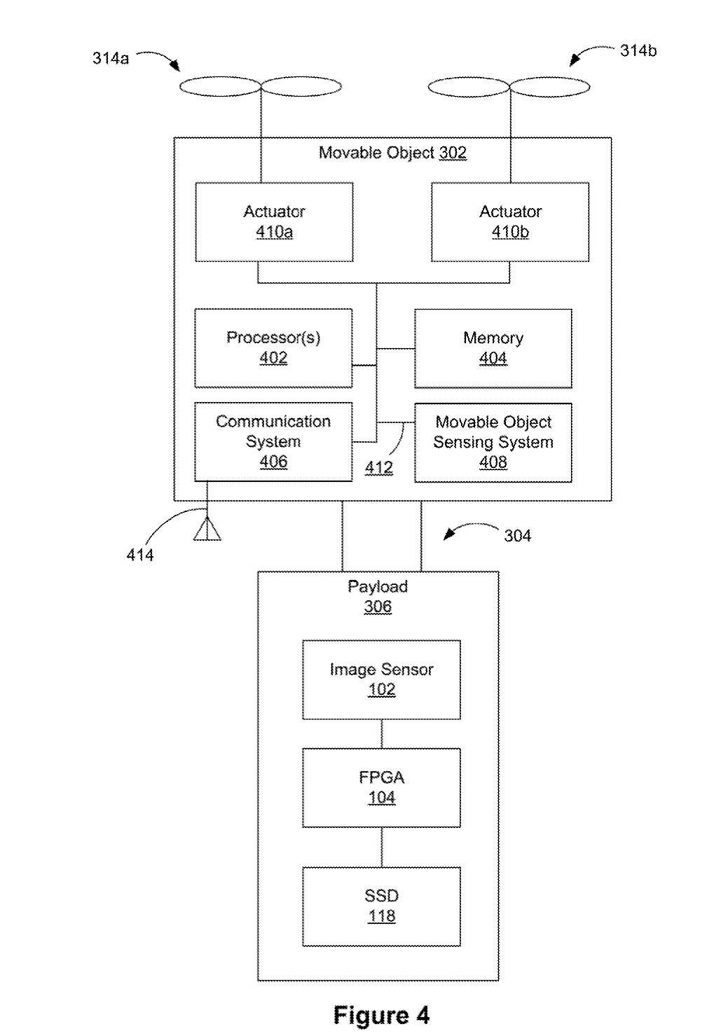

FIG. 3 illustrates a movable object environment 300, in accordance with some embodiments. The movable object environment 300 includes a movable object 302. In some embodiments, the movable object 302 includes a carrier 304 and/or a payload 306.

The following description uses an unmanned aerial vehicle (UAV) as an example of a movable object. UAVs include, e.g., fixed-wing aircrafts and rotary-wing aircrafts such as helicopters, quadcopters, and aircraft having other numbers and/or configurations of rotors. It will be apparent to those skilled in the art that other types of movable objects may be substituted for UAVs as described below.

In some embodiments, the carrier 304 is used to couple the payload 306 to the movable object 302. In some embodiments, the carrier 304 includes an element (e.g., a gimbal and/or damping element) to isolate the payload 306 from movement of the movable object 302 and/or the movement mechanism 314. In some embodiments, the carrier 304 includes an element for controlling movement of the payload 306 relative to the movable object 302.

In some embodiments, the payload 306 is coupled (e.g., rigidly coupled) to the movable object 302 (e.g., coupled via carrier 304) such that the payload 306 remains substantially stationary relative to movable object 302. For example, the carrier 304 is coupled to the payload 306 such that the payload is not movable relative to the movable object 302. In some embodiments, the payload 306 is mounted directly to the movable object 302 without requiring the carrier 304. In some embodiments, the payload 306 is located partially or fully within the movable object 302.

In some embodiments, the payload 306 includes an imaging device (e.g., a camera), such as an imaging device that includes image storage system 100.

In some embodiments, a control unit 308 communicates with the movable object 302, e.g., to provide control instructions to the movable object 302 and/or to display information received from the movable object 302. Although the control unit 308 is typically a portable (e.g., handheld) device, the control unit 308 need not be portable. In some embodiments, the control unit 308 is a dedicated control device (e.g., for the movable object 302), a laptop computer, a desktop computer, a tablet computer, a gaming system, a wearable device (e.g., glasses, a glove, and/or a helmet), a microphone, a portable communication device (e.g., a mobile telephone) and/or a combination thereof.

In some embodiments, an input device of the control unit 308 receives user input to control aspects of the movable object 302, the carrier 304, the payload 306, and/or a component thereof. Such aspects include, e.g., orientation, position, orientation, velocity, acceleration, navigation, and/or tracking. For example, a position of an input device of the control unit 308 (e.g., a position of a component of the input device) is manually set by a user to a position corresponding to an input (e.g., a predetermined input) for controlling the movable object 302. In some embodiments, the input device is manipulated by a user to input control instructions for controlling the navigation of the movable object 302. In some embodiments, an input device of control unit 308 is used to input a flight mode for the movable object 302, such as auto pilot or navigation according to a predetermined navigation path.

In some embodiments, a display of the control unit 308 displays information generated by the image storage system 100 and/or the movable object 302. For example, the display displays information about the movable object 302, the carrier 304, and/or the payload 306, such as position, attitude, orientation, movement characteristics of the movable object 302, and/or distance between the movable object 302 and another object (e.g., a target and/or an obstacle). In some embodiments, information displayed by a display of control unit 308 includes images captured by the image sensor 102. In some embodiments, information displayed by the display of the control unit 308 is displayed in substantially real-time as information is received by the control unit 308 from the movable object 302 and/or as the image data is acquired.

In some embodiments, the movable object environment 300 includes a computing device 310. The computing device 310 is, e.g., a server computer, a cloud server, a desktop computer, a laptop computer, a tablet, or another portable electronic device (e.g., a mobile telephone). In some embodiments, the computing device 310 is a base station that communicates (e.g., wirelessly) with the movable object 302 and/or the control unit 308. In some embodiments, the computing device 310 provides data storage, data retrieval, and/or data processing operations, e.g., to reduce the processing power and/or data storage requirements of the movable object 302 and/or the control unit 308. For example, the computing device 310 is communicatively connected to a database and/or the computing device 310 includes a database. In some embodiments, the computing device 310 is used in lieu of or in addition to the control unit 308 to perform any of the operations described with regard to the control unit 308.

In some embodiments, the movable object 302 communicates with a control unit 308 and/or a computing device 310, e.g., via wireless communications 312. In some embodiments, the movable object 302 receives information from the control unit 308 and/or the computing device 310. For example, information received by the movable object 302 includes, e.g., control instructions for controlling movable object 302. In some embodiments, the movable object 302 transmits information to the control unit 308 and/or the computing device 310. For example, information transmitted by the movable object 302 includes, e.g., images and/or video captured by the movable object 302.

In some embodiments, communications between the computing device 310, the control unit 308 and/or the movable object 302 are transmitted via a network (e.g., Internet 316) and/or a wireless signal transmitter (e.g., a long range wireless signal transmitter) such as a cellular tower 318. In some embodiments, a satellite (not shown) is a component of Internet 316 and/or is used in addition to or in lieu of the cellular tower 318.

In some embodiments, information communicated between the computing device 310, the control unit 308 and/or the movable object 302 include control instructions. Control instructions include, e.g., navigation instructions for controlling navigational parameters of the movable object 302 such as position, attitude, orientation, and/or one or more movement characteristics of the movable object 302, the carrier 304, and/or the payload 306. In some embodiments, control instructions include instructions directing movement of one or more of the movement mechanisms 314. For example, control instructions are used to control flight of a UAV.

In some embodiments, control instructions include information for controlling operations (e.g., movement) of the carrier 304. For example, control instructions are used to control an actuation mechanism of the carrier 304 so as to cause angular and/or linear movement of the payload 306 relative to the movable object 302. In some embodiments, the control instructions adjust movement of the carrier 304 relative to the movable object 302 with up to six degrees of freedom.

In some embodiments, control instructions are used to adjust one or more operational parameters for the payload 306. For example, the control instructions include instructions for adjusting a parameter of the image storage system (e.g., to start or stop storage of image data). In some embodiments, control instructions include instructions for adjusting imaging properties and/or image device functions, such as adjusting a distance between the image sensor 102 and an optical device, capturing an image, powering an imaging device on or off, adjusting an imaging mode (e.g., capturing still images or capturing video), and/or adjusting a position, orientation, and/or movement (e.g., pan rate, pan distance) of a carrier 304 and/or a payload 306.

FIG. 4 illustrates an exemplary movable object 302, in accordance with some embodiments. The movable object 302 typically includes one or more processor(s) 402, a memory 404, a communication system 406, a movable object sensing system 408, and one or more communication buses 412 for interconnecting these components. In some embodiments, processor(s) 402 include the FPGA 104, the memory 404 includes the SSD 118, and/or the movable object sensing system 408 includes the sensor interface 106.

In some embodiments, the movable object 302 is a UAV and includes components to enable flight and/or flight control. In some embodiments, the movable object 302 includes communication system 406 with one or more network or other communications interfaces (e.g., via which flight control instructions are received), one or more movement mechanisms 314 (e.g., 314a, 314b), and/or one or more movable object actuators 410 (e.g., 410a, 410b). Movable object actuators 410 cause movement of movement mechanisms 314, e.g., in response to received control instructions. Although the movable object 302 is depicted as an aircraft, this depiction is not intended to be limiting, and any suitable type of movable object can be used.

In some embodiments, the movable object 302 includes movement mechanisms 314 (e.g., propulsion mechanisms). Although the plural term “movement mechanisms” is used herein for convenience of reference, “movement mechanisms 314” refers to a single movement mechanism (e.g., a single propeller) or multiple movement mechanisms (e.g., multiple rotors). The movement mechanisms 314 include one or more movement mechanism types such as rotors, propellers, blades, engines, motors, wheels, axles, magnets, nozzles, and so on. The movement mechanisms 314 are coupled to the movable object 302 at, e.g., the top, bottom, front, back, and/or sides. In some embodiments, the movement mechanisms 314 of a single movable object 302 include multiple movement mechanisms of the same type. In some embodiments, the movement mechanisms 314 of a single movable object 302 include multiple movement mechanisms with different movement mechanism types. The movement mechanisms 314 are coupled to the movable object 302 using any suitable means, such as support elements (e.g., drive shafts) and/or other actuating elements (e.g., the movable object actuators 410). For example, a movable object actuator 410 receives control signals from the processor(s) 402 (e.g., via the control bus 412) that activate the movable object actuator 410 to cause movement of a movement mechanism 314. For example, the processor(s) 402 include an electronic speed controller that provides control signals to a movable object actuator 410.

In some embodiments, the movement mechanisms 314 enable the movable object 302 to take off vertically from a surface or land vertically on a surface without requiring any horizontal movement of the movable object 302 (e.g., without traveling down a runway). In some embodiments, the movement mechanisms 314 are operable to permit the movable object 302 to hover in the air at a specified position and/or orientation. In some embodiments, one or more of the movement mechanisms 314 (e.g., 314a) are controllable independently of one or more of the other movement mechanisms 314 (e.g., 314b). For example, when the movable object 302 is a quadcopter, each rotor of the quadcopter is controllable independently of the other rotors of the quadcopter. In some embodiments, multiple movement mechanisms 314 are configured for simultaneous movement.

In some embodiments, the movement mechanisms 314 include multiple rotors that provide lift and/or thrust to the movable object 302. The multiple rotors are actuated to provide, e.g., vertical takeoff, vertical landing, and hovering capabilities to the movable object 302. In some embodiments, one or more of the rotors spin in a clockwise direction, while one or more of the rotors spin in a counterclockwise direction. For example, the number of clockwise rotors is equal to the number of counterclockwise rotors. In some embodiments, the rotation rate of each of the rotors is independently variable, e.g., for controlling the lift and/or thrust produced by each rotor, and thereby adjusting the spatial disposition, velocity, and/or acceleration of the movable object 302 (e.g., with respect to up to three degrees of translation and/or up to three degrees of rotation).

The communication system 406 enables communication with the control unit 308 and/or the computing device 310, e.g., via wireless signals 312. The communication system 406 includes, e.g., transmitters, receivers, and/or transceivers for wireless communication. In some embodiments, the communication is one-way communication, such that data is only received by the movable object 302 from the control unit 308 and/or the computing device 310, or vice-versa. In some embodiments, communication is two-way communication, such that data is transmitted in both directions between the movable object 302 and the control unit 308 and/or the computing device 310. In some embodiments, the movable object 302, the control unit 308, and/or the computing device 310 are connected to the Internet 316 or other telecommunications network, e.g., such that data generated by the movable object 302, the control unit 308, and/or the computing device 310 is transmitted to a server for data storage and/or data retrieval (e.g., for display by a website).

In some embodiments, the sensing system 408 of the movable object 302 includes one or more sensors. In some embodiments, the one or more sensors of movable object sensing system 408 includes image sensor 102. In some embodiments, movable object sensing system 408 includes FPGA 104 and/or SSD 118. In some embodiments, one or more sensors of the movable object sensing system 408 are mounted to the exterior, located within, or otherwise coupled to the movable object 302. In some embodiments, one or more sensors of the movable object sensing system 408 are components of and/or coupled to the carrier 304 and/or the payload 306.

In some embodiments, the memory 404 stores one or more instructions, programs (e.g., sets of instructions), modules, controlling systems, controlling system configurations, and/or data structures, collectively referred to as “elements” herein. One or more elements described with regard to the memory 404 are optionally stored by the control unit 308, the computing device 310, and/or another device.

In some embodiments, the memory 404 stores a controlling system configuration that includes one or more system settings (e.g., as configured by a manufacturer, administrator, and/or user). For example, identifying information for the movable object 302 is stored as a system setting of the system configuration. In some embodiments, the controlling system configuration includes a configuration for the movable object sensing system 408. The configuration for the movable object sensing system 408 stores parameters such as position (e.g., of an optical device relative to the image sensor 102), zoom level and/or focus parameters (e.g., amount of focus, selecting autofocus or manual focus, and/or adjusting an autofocus target in an image). Imaging property parameters stored by memory 404 include, e.g., frame rate, image resolution, image size (e.g., image width and/or height), aspect ratio, pixel count, quality, focus distance, depth of field, exposure time, shutter speed, and/or white balance. In some embodiments, parameters stored by memory 404 are updated in response to control instructions (e.g., generated by processor(s) 402 and/or received by the movable object 302 from control unit 308 and/or the computing device 310).

In some embodiments, the controlling system includes instructions (e.g., to FPGA 104) for initiating and/or ceasing storage of the image data output of the image sensor 102. In some embodiments, the controlling system includes image processing instructions for processing raw image data to generate processed image data.

The above identified elements need not be implemented as separate software programs, procedures, or modules, and thus various subsets of these elements may be combined or otherwise re-arranged in various embodiments, and stored in the memory 404 and/or the FPGA 104. In some embodiments, the controlling system includes a subset of the elements identified above. Furthermore, the memory 404 and/or the FPGA 104 may store additional elements not described above. In some embodiments, the elements stored in the memory 404, the FPGA 104, and/or a non-transitory computer readable storage medium of memory 404 and/or FPGA 104, provides instructions for implementing respective operations in the methods described below. In some embodiments, some or all of these elements may be implemented with specialized hardware circuits that subsume part or all of the element functionality. One or more of the above identified elements may be executed by one or more processors 402 of the movable object 302 and/or by the FPGA 104 of the image storage system 100. In some embodiments, one or more of the above identified elements are stored on one or more storage devices of a device remote from the movable object (such as memory of the control unit 308, the computing device 310, and/or the memory 110 of the FPGA 104) and/or executed by one or more processors of a device remote from the movable object 302 (such as processor(s) of the control unit 308 and/or the computing device 310).

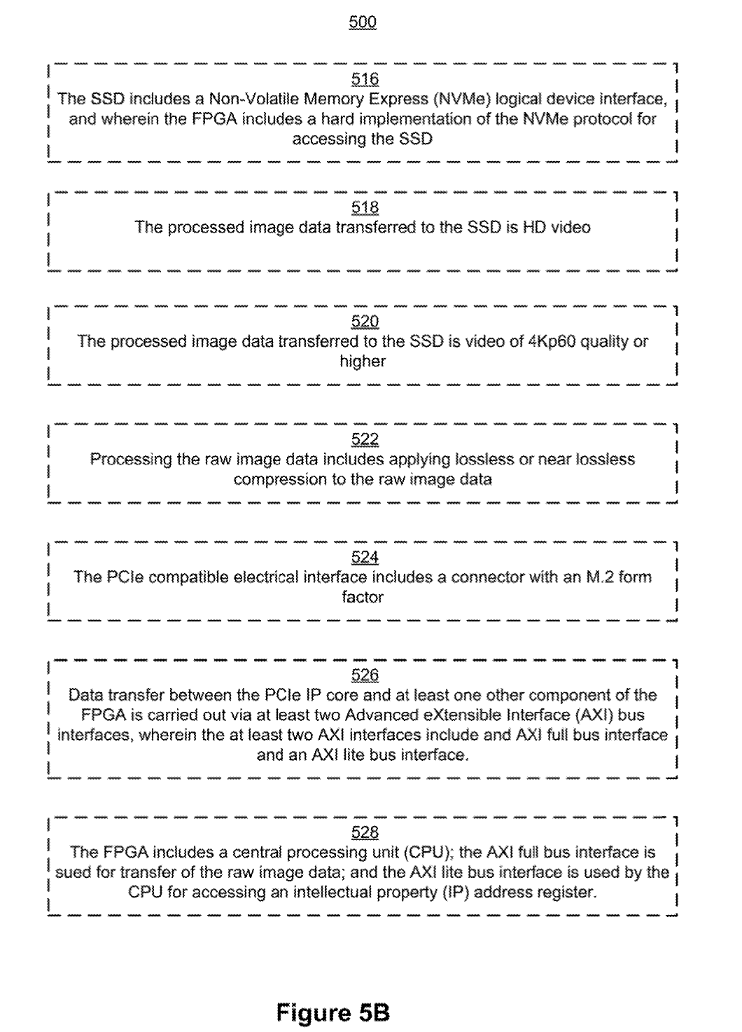

FIGS. 5A-5B are a flow diagram illustrating a method 500 for storing images, in accordance with some embodiments. The method 500 is performed at a device, such as the image storage system 100 and/or movable object 302. The device includes an image sensor 102, an SSD 118 that includes a PCIe compatible electrical interface 116, and an FPGA 104 coupled to the image sensor 102 and the SSD 118. The FPGA 104 implements a PCIe intellectual property (IP) core.

The device receives (502) raw image data 120 from the image sensor 102 (e.g., via the sensor interface 106). The device processes (504) the raw image data (e.g., by applying compression to the raw image data) to obtain processed image data 122. The device transfers (506) the processed image data 122 to the SSD 118 through the PCIe compatible electrical interface 116 of the SSD 118. The transfer through the PCIe compatible electrical interface 116 is driven the by PCIe IP core 112 of the FPGA 104.

In some embodiments, the PCIe IP core 112 of the FPGA 104 is configured (508) to have root complex (RC) functionality and the SSD 118 is configured as an endpoint (EP) that is driven by PCIe IP core 112.

In some embodiments, the PCIe IP core 112 is a hard IP implementation (510) in the FPGA 104, e.g., as indicated in FIG. 2A. For example, PCIe IP core 112 is a fixed-function gate-level IP implemented within the fixed silicon design of the FPGA fabric.

In some embodiments, the PCIe IP core 112 is a soft IP implementation (512) in the FPGA 104, e.g., as indicated in FIG. 2B. For example, PCIe IP core 112 is implemented in hardware description language.

In some embodiments, the SSD 118 includes (514) an NVMe logical device interface and the FPGA 104 includes a CPU 108 that executes a set of instructions implemented according to an NVMe protocol 200 to access the SSD 118 (e.g., for image storage and retrieval).

In some embodiments, the SSD 118 includes (516) an NVMe logical device interface and the FPGA 104 includes a hard implementation of an NVMe protocol 200 for accessing the SSD 118 (e.g., for image storage and retrieval). For example, as shown in FIG. 2A, in some embodiments NVMe protocol 200 is hardened in FPGA 104.

In some embodiments, the processed image data transferred to the SSD 106 is HD video (518).

In some embodiments, the processed image data transferred to the SSD 106 is video of 4Kp60 quality or higher (520).

In some embodiments, processing the raw image data includes (522) applying lossless or near lossless compression (e.g., HEVC/H.265 encoding) to the raw image data.

In some embodiments, the PCIe compatible electrical interface includes (524) a connector with an M.2 form factor.

In some embodiments, data transfer between the PCIe IP core 112 and at least one other component of the FPGA 104 is carried out via (526) at least two Advanced eXtensible Interface (AXI) bus interfaces (e.g., of the communication bus 114). The at least two AXI bus interfaces include an AXI full bus interface and an AXI lite bus interface.

In some embodiments (528), the FPGA 104 includes a central processing unit (CPU) 108; the AXI full bus interface is used for transfer of the raw image data; and the AXI lite bus interface is used by the CPU 108 for accessing an intellectual property (IP) address register (e.g., of the PCIe IP core 112).

Many features of the present disclosure can be performed in, using, or with the assistance of hardware, software, firmware, or combinations thereof. Consequently, features of the present disclosure may be implemented using a processing system. Exemplary processing systems (e.g., processor(s) 202) include, without limitation, one or more general purpose microprocessors (for example, single or multi-core processors), application-specific integrated circuits, application-specific instruction-set processors, field-programmable gate arrays, graphics processors, physics processors, digital signal processors, coprocessors, network processors, audio processors, encryption processors, and the like.

Features of the present disclosure can be implemented in, using, or with the assistance of a computer program product, such as a storage medium (media) or computer readable storage medium (media) having instructions stored thereon/in which can be used to program a processing system to perform any of the features presented herein. The storage medium (e.g., the memory 204) can include, but is not limited to, any type of disk including floppy disks, optical discs, DVD, CD-ROMs, microdrive, and magneto-optical disks, ROMs, RAMs, EPROMs, EEPROMs, DRAMs, VRAMs, DDR RAMs, flash memory devices, magnetic or optical cards, nanosystems (including molecular memory ICs), or any type of media or device suitable for storing instructions and/or data.

Stored on any one of the machine readable medium (media), features of the present disclosure can be incorporated in software and/or firmware for controlling the hardware of a processing system, and for enabling a processing system to interact with other mechanism utilizing the results of the present disclosure. Such software or firmware may include, but is not limited to, application code, device drivers, operating systems, and execution environments/containers.

Communication systems as referred to herein (e.g., the communication system 406) optionally communicate via wired and/or wireless communication connections. For example, communication systems optionally receive and send RF signals, also called electromagnetic signals. RF circuitry of the communication systems convert electrical signals to/from electromagnetic signals and communicate with communications networks and other communications devices via the electromagnetic signals. RF circuitry optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. Communication systems optionally communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. Wireless communication connections optionally use any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 302.11a, IEEE 302.11ac, IEEE 302.11ax, IEEE 302.11b, IEEE 302.11g and/or IEEE 302.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), spread spectrum technology such as FASST or DESST, or any other suitable communication protocol, including communication protocols not yet developed as of the filing date of this document.

While various embodiments of the present disclosure have been described above, it should be understood that they have been presented by way of example, and not limitation. It will be apparent to persons skilled in the relevant art that various changes in form and detail can be made therein without departing from the spirit and scope of the invention.

The present disclosure has been described above with the aid of functional building blocks illustrating the performance of specified functions and relationships thereof. The boundaries of these functional building blocks have often been arbitrarily defined herein for the convenience of the description. Alternate boundaries can be defined so long as the specified functions and relationships thereof are appropriately performed. Any such alternate boundaries are thus within the scope and spirit of the invention.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description of the present disclosure has been provided for the purposes of illustration and description. It is not intended to be exhaustive or to limit the invention to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for storing images, the system comprising:
an image sensor;
a solid-state drive (SSD) that includes a Peripheral Component Interconnect Express (PCIe) compatible electrical interface; and
a field-programmable gate array (FPGA) coupled to the image sensor and the SSD, wherein the FPGA implements a PCIe intellectual property (IP) core, and wherein the FPGA is configured to:
receive raw image data from the image sensor;
process the raw image data to obtain processed image data; and
transfer the processed image data to the SSD through the PCIe compatible electrical interface of the SSD, wherein the data transfer through the PCIe compatible electrical interface is driven by the PCIe IP core of the FPGA.

2. The system of claim 1, wherein the PCIe IP core of the FPGA is configured to have root complex (RC) functionality and the SSD is configured as an endpoint (EP) that is driven by the PCIe IP core.

3. The system of claim 1, wherein the PCIe IP core is either a hard IP implementation in the FPGA or a soft IP implementation in the FPGA.

4. The system of claim 1, wherein the SSD includes a Non-Volatile Memory Express (NVMe) logical device interface, and wherein the FPGA includes a central processing unit (CPU) that executes a set of instructions implemented according to an NVMe protocol to access the SSD.

5. The system of claim 1, wherein the SSD includes a Non-Volatile Memory Express (NVMe) logical device interface, and wherein the FPGA includes a hard implementation of an NVMe protocol for accessing the SSD. The system of claim 1, wherein processing the raw image data includes applying lossless or near lossless compression to the raw image data.

6. The system of claim 1, wherein the PCIe compatible electrical interface includes a connector with an M.2 form factor.

7. The system of claim 1, wherein data transfer between the PCIe IP core and at least one other component of the FPGA is carried out via at least two Advanced eXtensible Interface (AXI) bus interfaces, wherein the at least two AXI bus interfaces include an AXI full bus interface and an AXI lite bus interface.

8. The system of claim 7, wherein:
the FPGA includes a central processing unit (CPU);
the AXI full bus interface is configured to transfer the raw image data; and
the AXI lite bus interface is used by the CPU for accessing an intellectual property (IP) address register.

9. A method for storing images, the method comprising:
at an electronic device that includes an image sensor, a solid-state drive (SSD) that includes a Peripheral Component Interconnect Express (PCIe) compatible electrical interface, and a field-programmable gate array (FPGA) coupled to the image sensor and the SSD, wherein the FPGA implements a PCIe intellectual property (IP) core:
receiving raw image data from the image sensor;
processing the raw image data to obtain processed image data; and
transferring the processed image data to the SSD through the PCIe compatible electrical interface of the SSD, wherein the transfer through the PCIe compatible electrical interface is driven by the PCIe IP core of the FPGA.

10. The method of claim 9, wherein the PCIe IP core of the FPGA is configured to have root complex (RC) functionality and the SSD is configured as an endpoint (EP) that is driven by the PCIe IP core.

11. The method of claim 9, wherein the PCIe IP core is either a hard IP implementation in the FPGA or a soft IP implementation in the FPGA.

12. The method of claim 9, wherein the processed image data transferred to the SSD is HD video.

13. The method of claim 9, wherein the processed image data transferred to the SSD is video of 4Kp60 quality or higher.

14. The method of claim 9, wherein processing the raw image data includes applying lossless or near lossless compression to the raw image data.

15. The method of claim 9, wherein data transfer between the PCIe IP core and at least one other component of the FPGA is carried out via at least two Advanced eXtensible Interface (AXI) bus interfaces, wherein the at least two AXI bus interfaces include an AXI full bus interface and an AXI lite bus interface.

16. The method of claim 15, wherein:
the FPGA includes a central processing unit (CPU);
the AXI full bus interface is configured to transfer the raw image data; and
the AXI lite bus interface is used by the CPU for accessing an intellectual property (IP) address register.

17. An unmanned aerial vehicle (UAV), comprising:
a movement mechanism;
an image sensor;
a solid-state drive (SSD) that includes a Peripheral Component Interconnect Express (PCIe) compatible electrical interface; and
one or more processors, wherein:
the movement mechanism carries the image sensor, the SSD, and the one or more processors during movement,
the one or more processors includes a controller coupled to the movement mechanism and controls the movement mechanism,
the one or more processors includes a field-programmable gate array (FPGA) that is coupled to the image sensor and the SSD,
the FPGA implements a PCIe intellectual property (IP) core, and
the FPGA is configured to:
receive raw image data from the image sensor;
process the raw image data to obtain processed image data; and
transfer the processed image data to the SSD through the PCIe compatible electrical interface of the SSD, wherein the transfer through the PCIe compatible electrical interface is driven by the PCIe IP core of the FPGA.

18. The UAV of any of claim 17, wherein data transfer between the PCIe IP core and at least one other component of the FPGA is carried out via at least two Advanced eXtensible Interface (AXI) bus interfaces, wherein the at least two AXI bus interfaces include an AXI full bus interface and an AXI lite bus interface.

19. The UAV of claim 18, wherein:
the FPGA includes a central processing unit (CPU);
the AXI full bus interface is configured to transfer of the raw image data; and
the AXI lite bus interface is used by the CPU for accessing an intellectual property (IP) address register.
